(19) United States
(12) Patent Application Publication
(10) Pub. No.: US 2025/0199389 A1
(43) Pub. Date: Jun. 19, 2025

(54) ILLUMINATOR AND PROJECTOR

(71) Applicant: SEIKO EPSON CORPORATION, Tokyo (JP)

(72) Inventor: Koichi AKIYAMA, AZUMINO-SHI (JP)

(21) Appl. No.: 18/979,781

(22) Filed: Dec. 13, 2024

(30) Foreign Application Priority Data
Dec. 13, 2023 (JP) 2023-209938

(51) Int. Cl. G03B 21/20

(52) U.S. Cl. CPC G03B 21/208; G03B 21/2013; G03B 21/2066

(57) ABSTRACT

An illuminator includes: a first light source, a collimator element configured to parallelize the light from the first light source, a light collector configured to collect the light from the collimator element, and a deflector disposed between the collimator element and the light collector. The first light source includes a first light emitter configured to output first light along a first direction, and a second light emitter configured to output second light along the first direction. The first and second light emitters are arranged along a second direction. The collimator element includes a first lens having a first region that the first light enters and a second region that the second light enters. The first and second regions are arranged along the second direction in a state in which a first optical axis of the first lens is interposed therebetween. The deflector is configured to change a traveling direction of the first light and a traveling direction of the second light in such a way that a chief ray of the first light and a chief ray of the second light each travel along the first optical axis.

The present application is based on, and claims priority from JP Application Serial Number 2023-209938, filed Dec. 13, 2023, the disclosure of which is hereby incorporated by reference herein in its entirety.

### BACKGROUND

### 1. Technical Field

The present disclosure relates to an illuminator and a projector.

### 2. Related Art

To enhance the performance of projectors, there has been a proposed projector including an illuminator using a laser light source, which is a wide-color-gamut, high-efficiency light source. JP-A-2016-126904 discloses an illuminator including multiple semiconductor lasers, multiple collimator lenses that parallelize the beams output from the semiconductor lasers, a light collecting lens that collects the multiple beams, and a phosphor wheel that converts the wavelength part of the beams collected by the light collecting lens.

JP-A-2020-129578 discloses a light source apparatus including two semiconductor laser chips disposed on a single sub-mount and a single collimator lens that parallelizes the beams output from the two semiconductor laser chips. As described above, a laser light source having the configuration in which the beams output from two laser chips are caused to enter one collimator lens has been known as what is called a double-emitter laser light source.

JP-A-2020-129578 and JP-A-2016-126904 are examples of the related art.

In the illuminator JP-A-2016-126904, to increase the optical output while suppressing an increase in the size of the illuminator, it is conceivable to increase the optical density by increasing the number of the laser chips per region from which the laser beams are output, as in JP-A-2020-129578. JP-A-2020-129578 describes that the arrangement in which two semiconductor laser chips are simply disposed side by side causes light output from a lens to spread and results in a problem of a decrease in efficiency at which the light is used in a downstream optical system. In view of the fact described above, the problem described above is solved in JP-A-2020-129578 by employing a configuration in which the two semiconductor laser chips are disposed with the two semiconductor laser chips inclining with respect to each other and with respect to the direction of the optical axis of the lens.

In a mounting step of mounting the semiconductor laser chips on a substrate, however, it is very difficult to precisely mount the two semiconductor laser chips with the two semiconductor laser chips inclining with respect to each other. There is therefore a problem of an increase in the effort to carry out the mounting process.

### SUMMARY

To solve the problem described above, an illuminator according to an aspect of the present disclosure includes: a first light source configured to output light; a collimator element configured to parallelize the light output from the first light source; a light collector configured to collect light output collimator element and direct the collected light toward an illumination receiving region; and a deflector disposed between the collimator element and the light collector. The first light source includes a first substrate having a first surface, a first light emitter disposed at the first surface and configured to output first light along a first direction, and a second light emitter disposed at the first surface and configured to output second light along the first direction. The first and second light emitters are arranged along a second direction that intersects with the first direction. The collimator element includes a first lens having a first region that the first light enters and a second region that differs from the first region and the second light enters. The first and second regions are arranged along the second direction in a state in which a first optical axis of the first lens is interposed therebetween. The deflector is configured to change a traveling direction of the first light output from the first region and a traveling direction of the second light output from the second region in such a way that a chief ray of the first light and a chief ray of the second light each travel along the first optical axis.

A projector according to another aspect of the present disclosure includes the illuminator according the aspect of the present disclosure; a light modulator configured to modulate light containing combined light output from the illuminator in accordance with image information; and a projection optical apparatus configured to project the light modulated by the light modulator.

### BRIEF DESCRIPTION OF THE DRAWINGS

FIG. 1 is a schematic configuration diagram of a projector.

FIG. 2 is a schematic configuration diagram of an illuminator.

FIG. 3 is a perspective view of red laser light sources.

FIG. 4 is a front view of a first collimator lens array.

FIG. 5 is a perspective view of a constant deviation prism array.

FIG. 6 is an enlarged view of the constant deviation prism array.

FIG. 7 is an enlarged view of a constant deviation prism array according to a first variation.

FIG. 8 is an enlarged view of a constant deviation prism array according to a second variation.

FIG. 9 is a diagrammatic view showing a problem of an illuminator according to Comparative Example.

FIG. 10 is a diagrammatic view showing the effect of the illuminator shown in FIG. 2.

FIG. 11 is a graph showing the angular distribution of light before the light enters the constant deviation prism array.

FIG. 12 is a graph showing the angular distribution of the light after the light is output from the constant deviation prism array.

FIG. 13 shows the distribution of multiple beams output from the constant deviation prism array disposed at an optimum position.

FIG. 14 shows the intensity distribution of the multiple beams output from the constant deviation prism array disposed at a from the optimum position toward a collimator lens.

FIG. 15 shows the intensity distribution of the multiple beams output from the constant deviation prism array disposed at a position shifted from the optimum position away from the collimator lens.

FIG. 16 shows a result of a simulation on the intensity distribution of secondary light source images on a double-sided multi-lens array in the illuminator according to Comparative Example.

FIG. 17 shows a result of the simulation on the intensity distribution of the secondary light source images on the double-sided multi-lens array in the illuminator according to an embodiment of the present disclosure.

### DESCRIPTION OF EMBODIMENTS

An embodiment of the present disclosure will be described below with reference to the drawings.

A projector according to the present embodiment is an example of a liquid crystal projector including an illuminator using laser diodes.

In the following drawings, elements may be drawn at different dimensional scales for clarity of the elements.

A projector 10 according to the present embodiment is a projection-type image display apparatus that displays a color image on a screen (projection receiving surface) SCR. The projector 10 includes three light modulators corresponding to three types of color light, red light LR, green light LG, and blue light LB. The projector 10 includes laser diodes each capable of generating high-luminance, high-power light as light emitters of a light source apparatus.

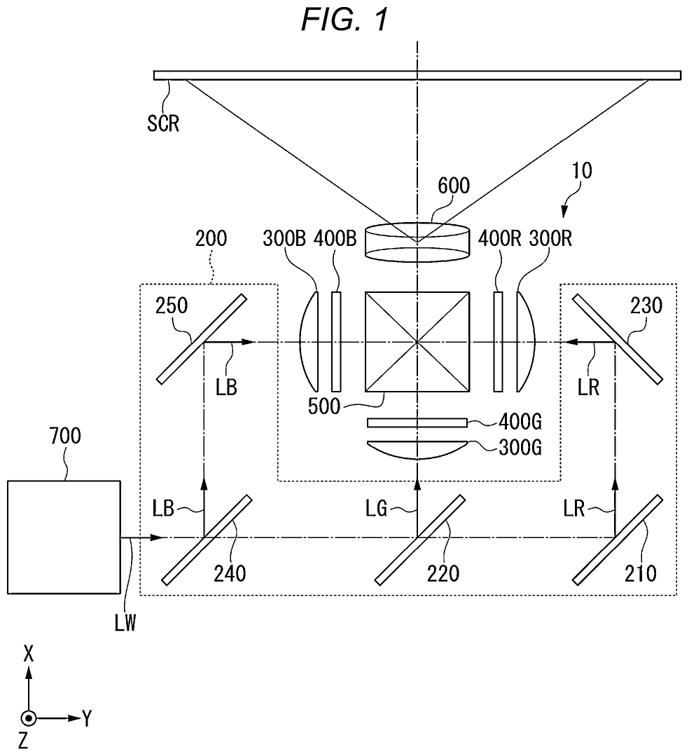

FIG. 1 is a schematic configuration diagram of the projector 10 according to the present embodiment.

The projector 10 includes an illuminator 700, a color separation/light guide system 200, a red light modulator 400R, a green light modulator 400G, a blue light modulator 400B, a light combining system 500, and a projection optical apparatus 600, as shown in FIG. 1. The red light modulator 400R, the green light modulator 400G, the blue light modulator 400B modulate light containing combined light LW output from the illuminator 700 in accordance with image information to form image light. The projection optical apparatus 600 projects the image light onto the screen SCR (projection receiving surface).

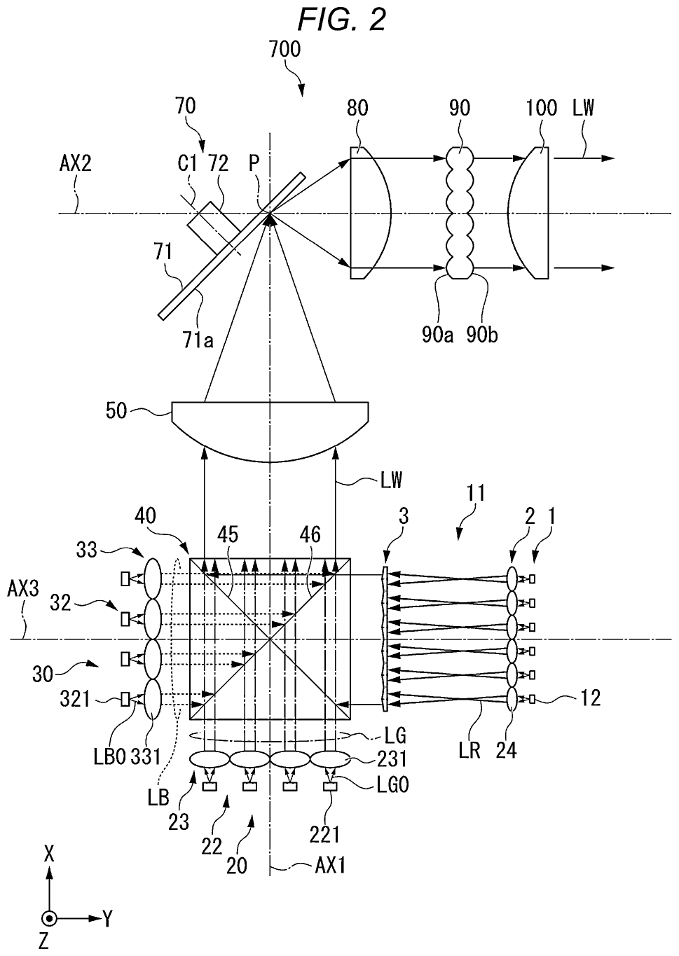

FIG. 2 is a schematic configuration diagram of the illuminator 700.

The illuminator 700 includes a red light source section 11, a green light source section 20, a blue light source section 30, a light combiner 40, a light collecting lens 50, a diffuser 70, a collimator lens 80, a double-sided multi-lens array 90, and a superimposing lens 100, as shown in FIG. 2.

In the following description, an axis parallel to the center axis of the green light LG output from the green light source section 20 is called an X-axis as a coordinate axis. An axis parallel to the center axis of the red light LR output from the red light source section 11 and the center axis of the blue light LB output from the blue light source section 30 is called a Y axis. An axis perpendicular to the X-axis and the Y-axis is called a Z-axis. An axis passing through a light collection point P on a diffusing surface 71a of a diffuser plate 71 and being parallel to the X axis is called an optical axis AX1. An axis passing through the light collection point P and being parallel to the Y axis (center axis of combined light LW output from diffuser plate 71) is called an optical axis AX2. The center axis of the red light LR output from the red light source section 11 and the center axis of the blue light LB output from the blue light source section 30 is called an optical axis AX3.

The red light source section 11 includes a red laser diode array 1, a first collimator lens array 2, and a constant deviation prism array 3. The red light source section 11 outputs red light LR having a predetermined peak wavelength along the Y-axis direction. The Y-axis direction in the present embodiment corresponds to the first direction in the claims.

The red laser diode array 1 includes multiple red laser light sources 12 arranged in an array. The red laser light sources 12 each output the red light LR having the predetermined peak wavelength in the −Y direction. The peak wavelength is, for example, 640 nm. In FIG. 2, the multiple red laser light sources 12 are arranged in the form of six rows along the X-axis direction, and also in the form of multiple columns along the direction perpendicular to the plane of view. The number and arrangement of the red laser light sources 12 are not limited to a specific number and a specific arrangement.

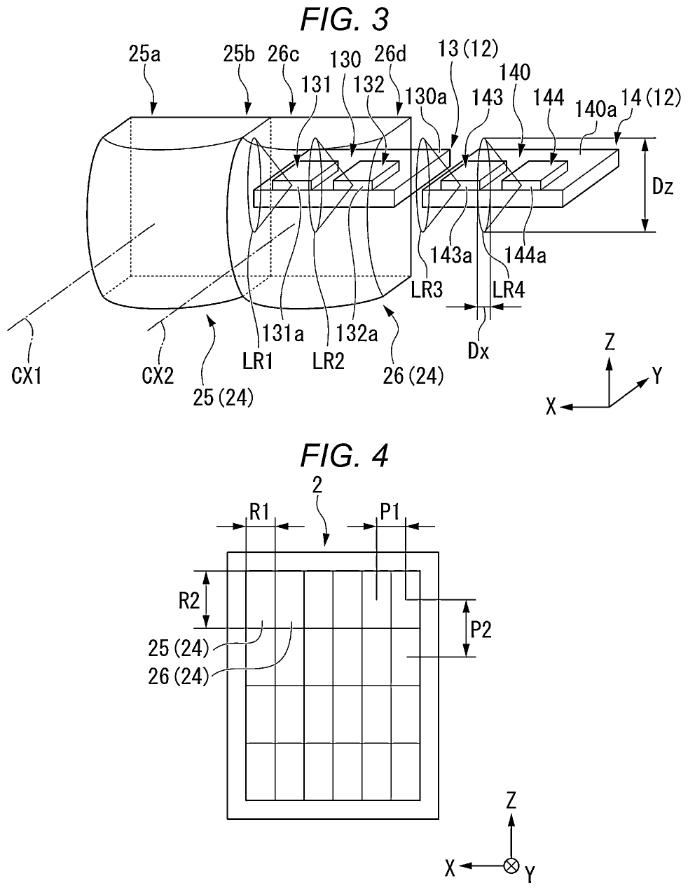

FIG. 3 is a perspective view of two red laser light sources 12 adjacent to each other in the X-axis direction. In FIG. 3, two red laser light sources adjacent to each other in the X-axis direction out of the multiple red laser light sources 12 are referred to as a first red laser light source 13 and a second red laser light source 14. The first red laser light source 13 is, for example, the laser light source located at the +X-side end (uppermost position in FIG. 2) in the red laser diode array 1 shown in FIG. 2. The second red laser light source 14 is, for example, the laser light source located at the second position (second position counted from top position in FIG. 2) from the +X-side end in the red laser diode array 1 shown in FIG. 2. The first red laser light source 13 in the present embodiment corresponds to the first light source in the claims. The second red laser light source 14 in the present embodiment corresponds to the second light source in the claims.

The first red laser light source 13 includes a first substrate 130, a first red laser diode 131, and a second red laser diode 132. The first substrate 130 has a first surface 130a. The first red laser diode 131 is provided at the first surface 130a of the first substrate 130 and outputs a first red beam LR1 along the Y-axis direction. The second red laser diode 132 is provided at the first surface 130a of the first substrate 130 and outputs a second red beam LR2 along the Y-axis direction. The first red laser diode 131 and the second red laser diode 132 are disposed at the first surface 130a along the X-axis direction. The first red laser diode 131 in the present embodiment corresponds to the first light emitter in the claims. The second red laser diode 132 in the present embodiment corresponds to the second light emitter in the claims. The X-axis direction in the present embodiment corresponds to the second direction in the claims. The first red beam LR1 in the present embodiment corresponds to the first light in the claims. The second red beam LR2 in the present embodiment corresponds to the second light in the claims.

The second red laser light source 14 includes a second substrate 140, a third red laser diode 143, and a fourth red laser diode 144. The second substrate 140 has a second surface 140a. The third red laser diode 143 is provided at the second surface 140a of the second substrate 140 and outputs a third red beam LR3 along the Y-axis direction. The fourth red laser diode 144 is provided at the second surface 140a of the second substrate 140 and outputs a fourth red beam LR4 along the Y-axis direction. The third red laser diode 143 and the fourth red laser diode 144 are disposed at the second surface 140a along the X-axis direction. The third red laser diode 143 in the present embodiment corresponds to the third light emitter in the claims. The fourth red laser diode 144 in the present embodiment corresponds to the fourth light emitter in the claims. The third red beam LR3 in the present embodiment corresponds to the third light in the claims. The fourth red beam LR4 in the present embodiment corresponds to the fourth light in the claims.

The first red laser diode 131, the second red laser diode 132, the third red laser diode 143, and the fourth red laser diode 144 have rectangular light emitting surfaces 131a, 132a, 143a, and 144a, respectively. The red laser diodes 131, 132, 143, and 144 are so arranged that the lengthwise direction of the light emitting surfaces 131a, 132a, 143a, and 144a is oriented in the X-axis direction, and the widthwise direction of the light emitting surfaces 131a, 132a, 143a, and 144a is oriented in the Z-axis direction. In general, since light output from a laser diode diverges due to diffraction that occurs at the light emitting surface, the divergence angle in the short-side direction of the light emitting surface is greater than the divergence angle in the long-side direction of the light emitting surface. Therefore, in the present embodiment, the divergence angle of the red beams LR1, LR2, LR3, and LR4 in the Z-axis direction is greater than the divergence angle of the red beams LR1, LR2, LR3, and LR4 in the X-axis direction. A luminous flux diameter Dz of the red beams LR1, LR2, LR3, and LR4 in the Z-axis direction is therefore greater than a luminous flux diameter Dx of the red beams LR1, LR2, LR3, and LR4 in the X-axis direction. The Z-axis direction in the present embodiment corresponds to the third direction in the claims.

The first collimator lens array 2 is provided at the light exiting side of the red laser diode array 1, as shown in FIG. 2. The first collimator lens array 2 includes multiple collimator lenses 24 provided in correspondence with the multiple respective red laser light sources 12. All the collimator lenses 24 have the same shape and the same size. The collimator lenses 24 are each configured with a convex lens. Since two red beams are output from two red laser diodes of one red laser light source 12, the red beams from the two red laser diodes enter one collimator lens 24. The collimator lens 24 parallelizes each of the red beams output from the red laser light sources 12. The first collimator lens array 2 in the present embodiment corresponds to the collimator element in the claims.

In the first collimator lens array 2, a first collimator lens 25 is provided in correspondence with the first red laser light source 13, and a second collimator lens 26 is provided in correspondence with the second red laser light source 14, as shown in FIG. 3. The first collimator lens 25 has a first region 25a, which the first red beam LR1 output from the first red laser diode 131 enters, and a second region 25b, which the second red beam LR2 output from the second red laser diode 132 enters. The first region 25a and the second region 25b are arranged along the X-axis direction in a state in which a first optical axis CX1 of the first collimator lens 25 is interposed therebetween. The second collimator lens 26 has a third region 26c, which the third red beam LR3 output from the third red laser diode 143 enters, and a fourth region 26d, which the fourth red beam LR4 output from the fourth red laser diode 144 enters. The third region 26c and the fourth region 26d are arranged along the X-axis direction in a state in which a second optical axis CX2 of the second collimator lens 26 is interposed therebetween. The first collimator lens 25 in the present embodiment corresponds to the first lens in the claims. The second collimator lens 26 in the present embodiment corresponds to the second lens in the claims.

FIG. 4 is a front view of the first collimator lens array 2.

A length R1 of the first collimator lens 25 in the X-axis direction is shorter than a length R2 of the first collimator lens 25 in the Z-axis direction, as shown in FIG. 4. That is, the first collimator lens 25 has a rectangular shape elongated in the Z-axis direction. Intervals P1 between the lenses of the first collimator lens array 2 in the X-axis direction are therefore shorter than intervals P2 between the lenses of the first collimator lens array 2 in the Z-axis direction. Note that the intervals P1 between the lenses of the first collimator lens array 2 in the X-axis direction are each the distance between the centers of two collimator lenses 24 adjacent to each other in the X-axis direction. The intervals P2 between the lenses of the first collimator lens array 2 in the Z-axis direction are each the distance between the centers of two collimator lenses 24 adjacent to each other in the Z-axis direction.

The red beams LR1, LR2, LR3, and LR4 output from the red laser diodes 131, 132, 143, and 144, respectively, each have a cross-sectional shape elongated in the Z-axis direction, as described above. Therefore, using a square collimator lens so shaped that each side thereof has a length that allows the red light to enter the collimator lens wastes opposite end portions of the collimator lens in the X-axis direction, resulting in a problem of an increase in the size of the collimator lens array. In contrast, according to the configuration of the present embodiment, since the length of the first collimator lens array 2 in the X-axis direction is not longer than necessary, the size of the first collimator lens array 2 can be reduced.

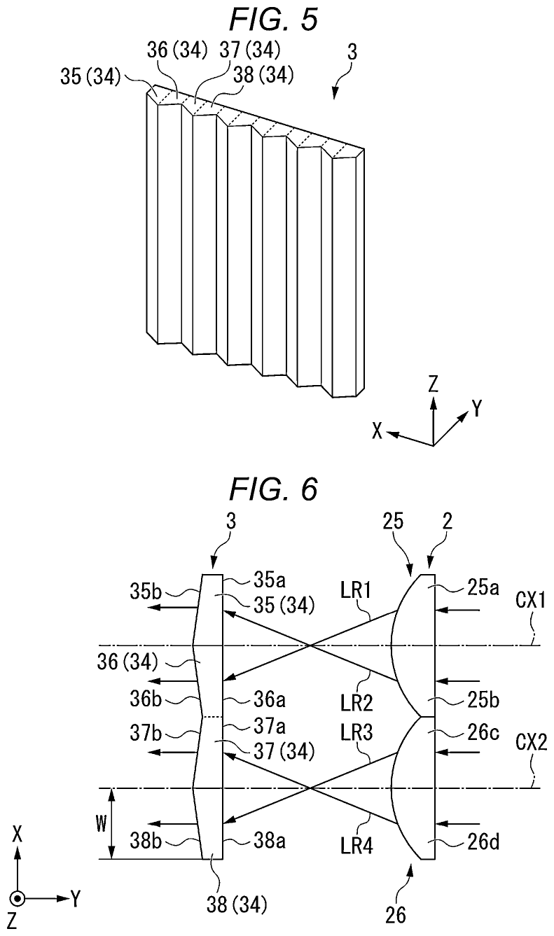

FIG. 5 is a perspective view of the constant deviation prism array 3.

The constant deviation prism array 3 has a configuration in which multiple quadrangular columnar constant deviation prisms 34 are arranged along the X-axis direction, as shown in FIG. 5. The entire constant deviation prism array 3 including the multiple constant deviation prisms 34 is configured with a monolithic light transmissive member. Each of the constant deviation prisms 34 has a trapezoidal cross-sectional shape perpendicular to the Z-axis and is elongated in the Z-axis direction. The constant deviation prisms 34 each have the function of refracting the chief ray of the light that enters the constant deviation prisms 34 in the direction parallel to the optical axis of the collimator lens 24 and outputting the refracted light. The constant deviation prism array 3 in the present embodiment corresponds to the deflector in the claims.

FIG. 6 is an enlarged plan view of the constant deviation prism array 3. FIG. 6 shows only a first constant deviation prism 35, a second constant deviation prism 36, a third constant deviation prism 37, and a fourth constant deviation prism 38 out of the multiple constant deviation prisms 34. FIG. 6 shows only the chief rays of the red beams LR1, LR2, LR3, and LR4.

The first red beam LR1 output from the first region 25a of the first collimator lens 25 enters the second constant deviation prism 36, as shown in FIG. 6. The second red beam LR2 output from the second region 25b of the first collimator lens 25 enters the first constant deviation prism 35. The third red beam LR3 output from the third region 26c of the second collimator lens 26 enters the fourth constant deviation prism 38. The fourth red beam LR4 output from the fourth region 26d of the second collimator lens 26 enters the third constant deviation prism 37.

The first constant deviation prism 35 has a first light incident surface 35a, on which the second red beam LR2 is incident, and a first light exiting surface 35b, via which the second red beam LR2 exits. The first light incident surface 35a is a perpendicular surface perpendicular to the first optical axis CX1 of the first collimator lens 25. The first light exiting surface 35b is an inclining surface inclining with respect to an imaginary plane perpendicular to the first optical axis CX1 of the first collimator lens 25. The first light exiting surface 35b inclines in such a way that the +X-side end thereof is shifted toward the +Y side and the −X-side end thereof is shifted toward the −Y side.

The second constant deviation prism 36 has a second light incident surface 36a, on which the first red beam LR1 is incident, and a second light exiting surface 36b, via which the first red beam LR1 exits. The second light incident surface 36a is a perpendicular surface perpendicular to the first optical axis CX1 of the first collimator lens 25. The second light exiting surface 36b is an inclining surface inclining with respect to the imaginary plane perpendicular to the first optical axis CX1 of the first collimator lens 25. The second light exiting surface 36b inclines in such a way that the +X-side end thereof is shifted toward the −Y side and the −X-side end thereof is shifted toward the +Y side. That is, the first light exiting surface 35b and the second light exiting surface 36b incline in opposite directions. The absolute value of the inclination angle of the first light exiting surface 35b is equal to the absolute value of the inclination angle of the second light exiting surface 36b.

The constant deviation prism array 3 changes the traveling direction of the first red beam LR1 output from the first region 25a of the first collimator lens 25 and the traveling direction of the second red beam LR2 output from the second region 25b of the first collimator lens 25 in such a way that the chief ray of the first red beam LR1 and the chief ray of the second red light LR2 travel along the first optical axis CX1 of the first collimator lens 25. The constant deviation prism array 3 changes the traveling direction of the third red beam LR3 output from the third region 26c of the second collimator lens 26 and the traveling direction of the fourth red beam LR4 output from the fourth region 26d of the second collimator lens 26 in such a way that the chief ray of the third red beam LR3 and the chief ray of the fourth red beam LR4 travel along the second optical axis CX2 of the second collimator lens 26. In the present specification, the fact described above that the chief ray of each of the red beams travels along the optical axis of the corresponding collimator lens means that the chief ray of each of the red beams is substantially parallel to the optical axis of the corresponding collimator lens.

The perpendicular surfaces and the inclining surfaces in the example described above may be swapped. That is, the first light incident surface 35a and the second light incident surface 36a may be inclining surfaces, and the first light exiting surface 35b and the second light exiting surface 36b may be perpendicular surfaces.

The configurations f the third constant deviation prism 37 and the fourth constant deviation prism 38 are the same as the configurations of the first constant deviation prism 35 and the second constant deviation prism 36. The third constant deviation prism 37 has a third light incident surface 37a, on which the fourth red beam LR4 is incident, and a third light exiting surface 37b, via which the fourth red beam LR4 exits. The fourth constant deviation prism 38 has a fourth light incident surface 38a, on which the third red beam LR3 is incident, and a fourth light exiting surface 38b, via which the third red beam LR3 exits. The positional relationship between the perpendicular surfaces and the inclining surfaces is the same as the positional relationship in the first constant deviation prism 35 and the second constant deviation prism 36.

The constant deviation prism array 3 may have the configuration below.

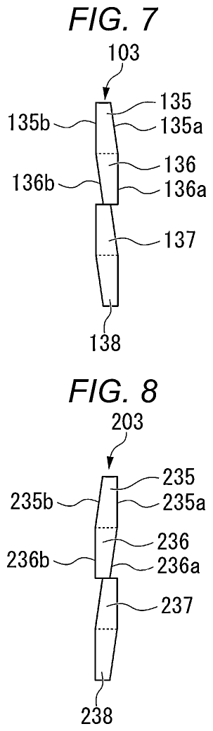

FIG. 7 is an enlarged plan view of a constant deviation prism array 103 according to a first variation.

In the constant deviation array 103 according to the first variation, a first light incident surface 135a of a first constant deviation prism 135 is an inclining surface, and a first light exiting surface 135b of the first constant deviation prism 135 is a perpendicular surface, as shown in FIG. 7. A second light incident surface 136a of a second constant deviation prism 136 is a perpendicular surface, and a second light exiting surface 136b of the second constant deviation prism 136 is an inclining surface. The configurations of a third constant deviation prism 137 and a fourth constant deviation prism 138 are the same as the configurations of the first constant deviation prism 135 and the second constant deviation prism 136.

FIG. 8 is an enlarged plan view of a constant deviation prism array 203 according to a second variation.

In the constant deviation prism array 203 according to the second variation, a first light incident surface 235a of a first constant deviation prism 235 is a perpendicular surface, and a first light exiting surface 235b of the first constant deviation prism 235 is an inclining surface, as shown in FIG. 8. A second light incident surface 236a of a second constant deviation prism 236 is an inclining surface, and a second light exiting surface 236b of the second constant deviation prism 236 is a perpendicular surface. The configurations of a third constant deviation prism 237 and a fourth constant deviation prism 238 are the same as the configurations of the first constant deviation prism 235 and the second constant deviation prism 236.

The constant deviation prism array 103 according to the first variation and the constant deviation prism array 203 according to the second variation also provide the same effects as those provided by the constant deviation prism array 3 in the present embodiment shown in FIG. 6. Therefore, in the constant deviation prism array in the present disclosure, one of the first light incident surface and the first light exiting surface may be an inclining surface, and one of the second light incident surface and the second light exiting surface may be an inclining surface. It is, however, desirable that either the first light incident surface 35a and the second light incident surface 36a or the first light exiting surface 35b and the second light exiting surface 36b are perpendicular surfaces perpendicular to the first optical axis CX1, as in the constant deviation prism array 3 in the present embodiment. The configuration described above, in which the light incident surfaces or the light exiting surfaces are perpendicular surfaces extending throughout all the constant deviation prisms 34, can provide advantages, for example, the constant deviation prism array 3 can be readily manufactured and implemented, and optical loss due to the step at the boundary between the second and third constant deviation prisms shown in each of the variations in FIGS. 7 and 8 can be suppressed.

The effects of the constant deviation prism array will be described below.

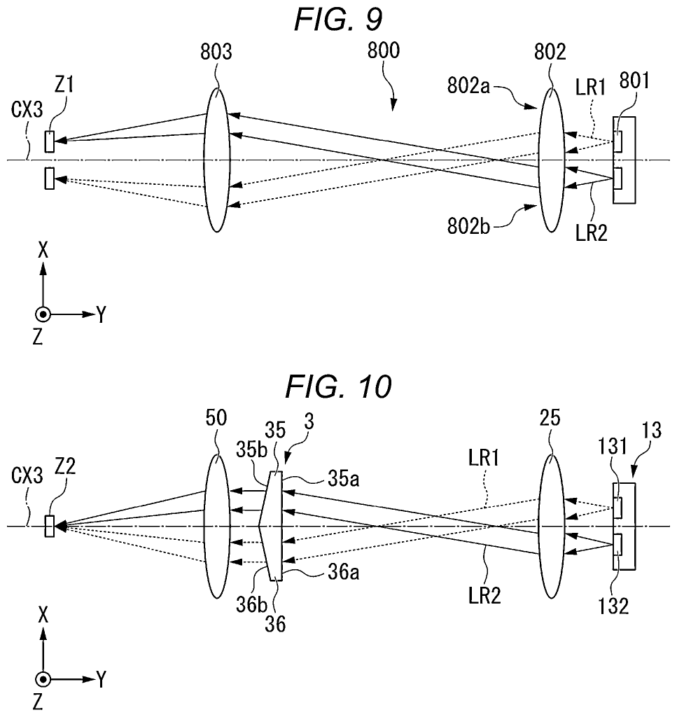

FIG. 9 is a diagrammatic view showing a problem of an illuminator 800 according to Comparative Example.

The illuminator 800 according to Comparative Example includes no constant deviation prism array, as shown in FIG. 9. The illuminator 800 according to Comparative Example includes a laser light source having the configuration in which the beams from two laser diodes 801 enter one collimator lens 802, that is, what is called a double-emitter laser light source. In this case, the chief rays of red beams LR1 and LR2 do not coincide with an optical axis CX3 of the collimator lens 802 but enter two regions 802a and 802b of the collimator lens 802, which sandwich the optical axis CX3. In this case, the red beams LR1 and LR2 output from the laser diodes 801 at a predetermined divergence angle are parallelized by the collimator lens 802. The red beams LR1 and LR2 are, however, incident on the collimator lens 802 at positions shifted from the optical axis CX3, and therefore output from the collimator lens 802 not in the direction parallel to the optical axis CX3 but in a direction intersecting the optical axis CX3.

Thereafter, when the red beams LR1 and LR2 output from the collimator lens 802 are collected by a light collecting lens 803, secondary light source images of the laser diodes 801 are formed in the focal plane of the light collecting lens 803. However, since the red beams LR1 and LR2 do not enter the light collecting lens 803 in parallel to the optical axis thereof, the red beams LR1 and LR2 are not focused at a single point on the optical axis CX3, but two secondary light source images Z1 are formed at positions that sandwich the optical axis CX3. Therefore, when an illumination receiving region is placed at the focal position of the light collecting lens 803, there is a problem of spatial spread of the secondary light source images in the illumination receiving region.

FIG. 10 is a diagrammatic view showing the effect of the constant deviation prism array 3 in the present embodiment.

In the present embodiment, the constant deviation prism array 3 is provided between the first collimator lens 25 and the light collecting lens 50, as shown in FIG. 10. The red beams LR1 and LR2 output from the first collimator lens 25 therefore enter the first constant deviation prism 35 and the second constant deviation prism 36 of the constant deviation prism array 3, respectively. Since the constant deviation prisms 35 and 36 have the function of refracting the chief rays of the red beams LR1 and LR2 in the direction parallel to the optical axis CX3, and the first constant deviation prism 35 and the second constant deviation prism 36 have inclining surfaces inclining in opposite directions, the chief rays of the red beams LR1 and LR2 output from the constant deviation prism array 3 are parallel to the optical axis CX3. As described above, in the present embodiment, since the red beams LR1 and LR2 enter the light collecting lens 50 in parallel to the optical axis CX3 thereof, the red beams LR1 and LR2 are focused at a single point on the optical axis CX3, and a single secondary light source image Z2 is formed, unlike in Comparative Example. As described above, the constant deviation prism array 3 in the present embodiment allows suppression of the spatial spread of the secondary light source image in the illumination receiving region due to the use of the double-emitter first red laser light source 13.

The person who discloses the present disclosure has conducted a simulation on the angular distribution of the light before and after the light enters the constant deviation prism array 3.

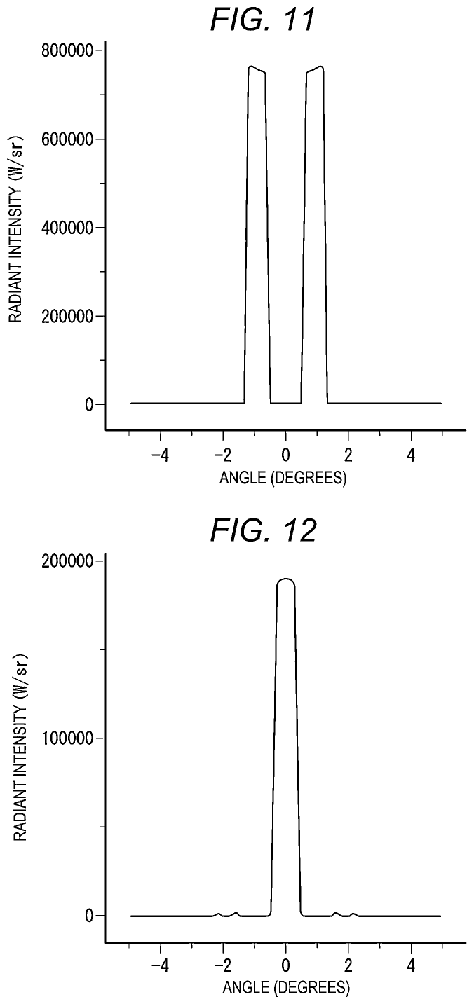

FIGS. 11 and 12 are graphs showing results of the simulation of the angular distribution of the light.

FIG. 11 is a graph showing the angular distribution of the light before the light enters the constant deviation prism array 3. FIG. 12 is a graph showing the angular distribution of the light after the light is output from the constant deviation prism array 3. In FIGS. 11 and 12, the horizontal axis represents the angle (degree) of the light on the assumption that the direction parallel to the optical axis CX3 is 0 degree. The vertical axis is the radiant intensity (W/sr) of the light.

The light before entering the constant deviation prism array 3 has two angular components, an angular component that peaks at +1 degree and an angular component that peaks at −1 degree, as sown in FIG. 11. In contrast, the light output from the constant deviation prism array 3 peaks only at 0 degrees, as shown in FIG. 12. It is thus demonstrated that most of the light having the two angular components and entering the constant deviation prism array 3 is converted into light parallel to the optical axis CX3 after passing through the constant deviation prism array 3. The graph shown in FIG. 12 shows very small peaks at positions of +2 degrees and −2 degrees. The peaks indicate that a very small portion of the light that obliquely enters the constant deviation prism array 3 does not enter the constant deviation prism that the light is supposed to enter but enters another constant deviation prism adjacent thereto, resulting in components that are not refracted in the direction parallel to the optical axis CX3 but are refracted in directions away from the optical axis CX3.

The optimum position of the constant deviation prism array 3 will be described below.

The person who discloses the present disclosure conducted a simulation on the intensity distributions of multiple beams by changing the on-axis position of the constant deviation prism array 3 along the optical axis.

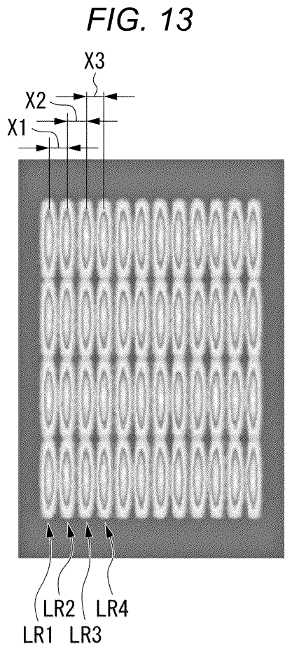

FIG. 13 is a result of the simulation on the intensity distribution of the multiple beams output from the constant deviation prism array disposed at an optimum position. The results of the simulation shown in FIGS. 13 to 15 below show the intensity distribution produced when the beams are projected onto an imaginary plane perpendicular to the first optical axis CX1 and the second optical axis CX2 between the first collimator lens array 2 and the light collecting lens 50.

When the constant deviation prism array 3 is disposed at the optimum position, the distances between the beams adjacent to each other in the X-axis direction are equal to each other, as shown in FIG. 13. The distances between the beams adjacent to each other in the X-axis direction are each defined as the distance between the center axes of the beams adjacent to each other in the X-axis direction, and the distance between the centers at which the intensities of the beams adjacent to each other in the X-axis direction in FIG. 13 are maximized. Specifically, a first distance X1 along the X-axis direction between the first red beam LR1 and the second red beam LR2, a second distance X2 along the X-axis direction between the second red beam LR2 and the third red beam LR3, and a third distance X3 along the X-axis direction between the third red beam LR3 and the fourth red beam LR4 are equal to each other. Note that the distances being equal to each other includes the distances being substantially equal to each other. When the distances are substantially equal to each other, there may, for example, be a difference of about 10% or smaller between one distance and the other distance.

In this case, the intervals between the constant deviation prisms of the constant deviation prism array 3 are desirably set equal to the first distance X1, the second distance X2, and the third distance X3. The configuration described above can minimize loss that occurs when the red light LR passes through a constant deviation prism 34 that the red light LR is not supposed to enter, and therefore allows use of the red light LR at increased efficiency. The intervals between the constant deviation prisms of the constant deviation prism array 3 described above are defined as a width W of one constant deviation prism 34 shown in FIG. 6 in the X-axis direction. Note that the intervals between the constant deviation of the constant deviation prism array 3 being equal to each of the distances X1, X2, and X3 includes the intervals being substantially equal to each of the distances. When the intervals are substantially equal to each of the distances, there may, for example, be a difference of about 10% or smaller between the intervals and each of the distances.

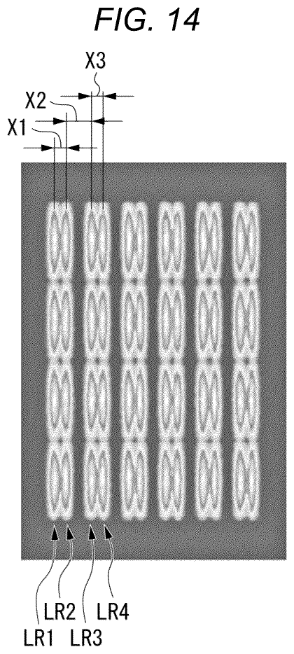

FIG. 14 shows the intensity distributions of the multiple beams output from the constant deviation prism array 3 disposed at a position shifted toward the first collimator lens array 2 from the optimum position of the constant deviation prism array 3 shown in FIG. 6.

When the position of the constant deviation prism array 3 is shifted toward the first collimator lens array 2 from the optimum position, the distances between the beams adjacent to each other in the X-axis direction are not equal to each other, as shown in FIG. 14. Specifically, the first distance X1 between the first red beam LR1 and the second red beam LR2, and the third distance X3 between the third red beam LR3 and the fourth red beam LR4 are smaller than the second distance X2 between the second red beam LR2 and the third red beam LR3.

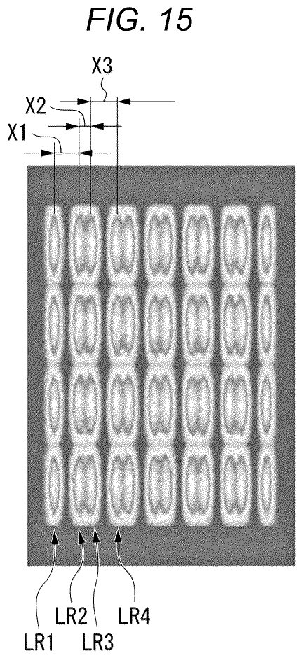

FIG. 15 shows the intensity distributions of the multiple beams output from the constant deviation prism array 3 disposed at a position shifted away from the first collimator lens array 2 from the optimum position of the constant deviation prism array 3 shown in FIG. 6.

When the position of the constant deviation prism array 3 is shifted away from the first collimator lens array 2 from the optimum position, the distances between the beams adjacent to each other in the X-axis direction are not equal to each other, as shown in FIG. 15. Specifically, the first distance X1 between the first red beam LR1 and the second red beam LR2 and the third distance X3 between the third red beam LR3 and the fourth red beam LR4 are greater than the second distance X2 between the second red beam LR2 and the third red beam LR3.

When the constant deviation prism array 3 is not disposed at the optimum position, part of the red light does not the constant deviation prism that the red light is supposed to enter but enters another constant deviation prism adjacent thereto, as shown in FIGS. 14 and 15. As a result, the red light having entered the other constant deviation prism is refracted in a direction away from the optical axis and travels accordingly, resulting in optical loss, so that the red light is used at decreased efficiency. Therefore, not to use the red light at decreased efficiency, it is desirable that the constant deviation prism array 3 is disposed between the first collimator lens array 2 and the light collecting lens 50 at a position where the first distance X1 between the first red beam LR1 and the second red beam LR2, the second distance X2 between the second red beam LR2 and the third red beam LR3, and the third distance X3 between the third red beam LR3 and the fourth red beam LR4 are equal to each other when the first red beam LR1, the second red beam LR2, the third red beam LR3, and the fourth red beam LR4 are projected onto an imaginary plane perpendicular to the first optical axis CX1 and the second optical axis CX2, as shown in FIG. 13.

The green light source section 20 includes a green laser diode array 22 and a second collimator lens array 23, as shown in FIG. 2.

The green laser diode array 22 includes multiple green laser diodes 221 arranged in an array. The green laser diodes 221 each output a green beam LG0, which belongs to a second wavelength band, in the +X direction. The second wavelength band is, for example, 535 nm+10 nm. The number and the arrangement of the green laser diodes 221 are not limited to a specific number and a specific arrangement.

The second collimator lens array 23 is disposed at the light exiting side of the green laser diode array 22. The second collimator lens array 23 includes multiple collimator lenses 231 provided in correspondence with the multiple respective green laser diodes 221. The collimator lenses 231 are each configured with a convex lens. The collimator lenses 231 each parallelize the green beam LG0 output from the corresponding green laser diode 221. The multiple green beams LG0 output from the second collimator lens array 23 are hereinafter collectively referred to as the green light LG. The green light LG is therefore parallelized light parallelized by the second collimator lens array 23.

The blue light source section 30 includes a blue laser diode array 32 and a third collimator lens array 33.

The blue laser diode array 32 includes multiple blue laser diodes 321 arranged in an array. The blue laser diodes 321 each output a blue beam LB0, which belongs to a third wavelength band, in the +Y direction. The third wavelength band is, for example, 455 nm+10 nm. The number and the arrangement of the blue laser diodes 321 are not limited to a specific number and a specific arrangement.

The third collimator lens array 33 is disposed at the light exiting side of the blue laser diode array 32. The third collimator lens array 33 includes multiple collimator lenses 331 provided in correspondence with the multiple respective blue laser diodes 321. The collimator lenses 331 are each configured with a convex lens. The collimator lenses 331 each parallelize the blue beam LB0 output from the corresponding blue laser diode 321. The multiple blue beams LB0 output from the third collimator lens array 33 are hereinafter collectively referred to as the blue light LB. The blue light LB is therefore parallelized light parallelized by the third collimator lens array 33.

The light combiner 40 is configured with a cross dichroic prism. The cross dichroic prism includes a first dichroic mirror 45 and a second dichroic mirror 46. The first dichroic mirror 45 reflects the red light LR and transmits the green light LG and the blue light LB. The second dichroic mirror 46 reflects the blue light LB and transmits the green light LG and the red light LR. The light combiner 40 therefore combines the red light LR output from the red light source section 11, the green light LG output from the green light source section 20, and the blue light LB output from the blue light source section 30 with one another, and outputs the combined light LW, which is white light, toward the light collecting lens 50. Since each the three types of color light that enter the light combiner 40 are each linearly polarized light, the combined light LW output from the light combiner 40 is also linearly polarized light.

The light collecting lens 50 is provided at the light exiting side of the light combiner 40. The light collecting lens 50 is configured with a convex lens. The light collecting lens 50 collects the white combined light LW output from the light combiner 40 and outputs the collected combined light LW toward the diffuser plate 71. The light collecting lens 50 in the present embodiment corresponds to the light collector in the claims.

The diffuser 70 includes the diffuser plate 71, which is a disk-shaped plate, and a driver 72. The diffuser plate 71 has the diffusing surface 71a, which diffusely reflects the combined light LW output from the light collecting lens 50. That is, the diffuser plate 71 in the present embodiment is not a transmissive diffuser plate but is a reflective diffuser plate. The diffuser plate 71 is disposed at a position where the diffusing surface 71a intersects with each of the optical axes AX1 and AX2. The diffusing surface 71a inclines by an angle of 45 degrees with respect to each of the optical axes AX1 and AX2. The diffusing surface 71a of the diffuser plate 71 is disposed at the light collection point P, at which the combined light LW collected by the light collecting lens 50 is collected. In other words, the focal point of the light collecting lens 50 is located on the diffusing surface 71a of the diffuser plate 71. The diffusing surface 71a in the present embodiment corresponds to the illumination receiving region in the claims.

The diffuser plate 71 includes, for example, a light transmissive substrate, a metal reflection film, and a dielectric multilayer film. The light transmissive substrate is made, for example, of optical glass such as BK7, and has one surface provided with an irregular structure including multiple recesses and multiple protrusions. The metal reflection film is provided along the irregular structure of the light transmissive substrate. The metal reflection film is made, for example, of material containing aluminum. The dielectric multilayer film is provided at a surface of the metal reflection film that is the surface opposite the light transmissive substrate. The dielectric multilayer film has a configuration in which two types of dielectric films different in refractive index from each other are alternately layered on each other multiple times. The diffuser plate 71 may be a microlens-array-type diffuser plate including a microlens array. In the diffuser plate 71, the dielectric multilayer film may be directly formed on the irregular structure of the light transmissive substrate. The diffuser plate 71 may instead be configured with a metal substrate and the dielectric multilayer film.

The driver 72 is configured with a motor and rotates the diffuser plate 71 around an axis of rotation C1, which intersects with the diffusing surface 71a. Rotating the diffuser plate 71 can reduce speckle noise that is likely to occur when a laser light source is used.

The collimator lens 80 is provided in the optical axis AX2 at the light exiting side of the diffuser plate 71. The collimator lens 80 is configured with a convex lens. The collimator lens 80 parallelizes the combined light LW output from the diffuser plate 71 at a predetermined diffusion angle, and outputs the parallelized combined light LW toward the double-sided multi-lens array 90.

The double-sided multi-lens array 90 and the superimposing lens 100 form an optical integration system. The optical integration system homogenizes the illuminance distribution of the combined light LW output from the collimator lens 80 in an image formation region of each of the red light modulator 400R, the green light modulator 400G, and the blue light modulator 400B.

The double-sided multi-lens array 90 is provided in the optical axis AX2 at the light exiting side of the collimator lens 80. The double-sided multi-lens array 90 is a multi-lens array that is a single member into which a first multi-lens surface 90a and a second multi-lens surface 90b are integrated with each other. The first multi-lens surface 90a includes multiple lenses that divide the combined light LW output from the collimator lens 80 into multiple sub-luminous fluxes. The multiple lenses are arranged in a matrix in a plane perpendicular to the optical axis AX2.

The second multi-lens surface 90b includes multiple lenses corresponding to the multiple lenses at the first multi-lens surface 90a. The second multi-lens surface 90b along with the downstream superimposing lens 100 forms images of the lenses at the first multi-lens surface 90a in the image formation region of each of the red light modulator 400R, the green light modulator 400G, and the blue light modulator 400B or in the vicinity of the image formation region. The multiple lenses are arranged in a matrix in a plane perpendicular to the optical axis AX2. Note that the first multi-lens surface 90a and the second multi-lens surface 90b may be separately provided in the form of two multi-lens arrays. Furthermore, a driver that vibrates or swings the double-sided multi-lens array 90 in a direction perpendicular to the optical axis AX2 (direction along the XZ plane) may be provided. Vibrating or swinging the double-sided multi-lens array 90 can reduce speckle noise that is likely to occur when a laser diode is used.

The superimposing lens 100 collects each of the multiple sub-luminous fluxes output from the double-sided multi-lens array 90 and superimposes the collected sub-luminous fluxes on one another in the image formation region of each of the red light modulator 400R, the green light modulator 400G, and the blue light modulator 400B or in the vicinity of the image formation region.

The color separation/light guide system 200 includes dichroic mirrors 240 and 220, and reflection mirrors 210, 230, and 250, as shown in FIG. 1. The color separation/light guide system 200 separates the white combined light LW output from the illuminator 700 into the red light LR, the green light LG, and the blue light LB, and guides the red light LR, the green light LG, and the blue light LB to the red light modulator 400R, the green light modulator 400G, and the blue light modulator 400B corresponding respectively thereto.

A field lens 300R is disposed between the color separation/light guide system 200 and the red light modulator 400R. A field lens 300G is disposed between the color separation/light guide system 200 and the green light modulator 400G. A field lens 300B is disposed between the color separation/light guide system 200 and the blue light modulator 400B.

The dichroic mirror 240 reflects the blue light LB and transmits the red light LR and the green light LG. The dichroic mirror 220 reflects the green light LG and transmits the red light LR. The reflection mirrors 210 and 230 each reflect the red light LR. The reflection mirror 250 reflects the blue light LB.

The red light modulator 400R is configured with a liquid crystal panel that modulates the red light LR in accordance with image information to form an image. The green light modulator 400G is configured with a liquid crystal panel that modulates the green light LG in accordance with image information to form an image. The blue light modulator 400B is configured with a liquid crystal panel that modulates the blue light LB in accordance with image information to form an image.

Although not shown, light-incident-side polarizers are disposed between the field lens 300R and the red light modulator 400R, between the field lens 300G and the green light modulator 400G, and between the field lens 300B and the blue light modulator 400B. Light-exiting-side polarizers are disposed between the red light modulator 400R and the light combining system 500, between the green light modulator 400G and the light combining system 500, and between the blue light modulator 400B and the light combining system 500. Note that the light-incident-side polarizers may not be provided when disturbance of the polarization caused by an optical system downstream from the illuminator 700 is acceptable.

The light combining system 500 combines the image light output from the red light modulator 400R, the image light output from the green light modulator 400G, and the image light output from the blue light modulator 400B with one another. The light combining system 500 is configured with a cross dichroic prism including four rectangular prisms bonded to each other and therefore having a substantially square shape in a plan view. In the cross dichroic prism, dielectric multilayer films are provided at the interfaces having a substantially X shape formed by the rectangular prisms bonded to each other.

The image light output from the light combining system 500 is enlarged and projected onto the screen SCR by the projection optical apparatus 600. The projection optical apparatus 600 is configured with multiple lenses.

### Advantages of First Embodiment

The illuminator 700 according to the present embodiment includes the first red laser light source 13, which outputs the red light LR, the first collimator lens array 2, which parallelizes the red light LR output from the first red laser light source 13, the light collecting lens 50, which collects the red light LR output from the first collimator lens array 2 and directs the collected red light LR toward the diffuser plate 71, and the constant deviation prism array 3 provided between the first collimator lens array 2 and the light collecting lens 50. The first red laser light source 13 includes the first substrate 130 having the first surface 130a, the first red laser diode 131, which is provided at the first surface 130a and outputs the first red beam LR1 along the Y-axis direction, and the second red laser diode 132, which is provided at the first surface 130a and outputs the second red beam LR2 along the Y-axis direction. The first red laser diode 131 and the second red laser diode 132 are arranged along the X-axis direction. The first collimator lens array 2 includes the first collimator lens 25 having the first region 25a, which the first red beam LR1 enters, and the second region 25b, which the second red beam LR2 enters. The first region 25a and the second region 25b are arranged along the X-axis direction in a state in which the first optical axis CX1 of the first collimator lens 25 is interposed therebetween. The constant deviation prism array 3 changes the traveling direction of the first red beam LR1 and the traveling direction of the second red beam LR2 in such a way that the chief ray of the first red beam LR1 output from the first region 25a and the chief ray of the second red beam LR2 output from the second region 25b travel along the first optical axis CX1.

The illuminator 700 according to the present embodiment can suppress spatial spread of the secondary light source images on the diffuser plate 71 due to the use of the double-emitter laser light source as each of the red laser light sources 12, as described with reference to FIG. 10. Loss of the red light LR in a downstream optical system can thus be suppressed, so that the red light LR can be used at increased efficiency. Furthermore, according to the present embodiment, since the two mounted laser diodes do not need to be implemented with the two laser diodes inclining with respect to each other, unlike in the laser light source of the related art, the effort to mount the laser diodes is not increased.

The reason why the double-emitter laser light source is used as each of the red laser light sources 12 is that the optical output of a currently provided red laser diode is slower than that of the other color laser diodes, and furthermore, human eyes have high spectral luminous efficiency to green light. Therefore, using a double-emitter laser light source as each of the red laser light sources 12 does not sufficiently improve the optical output when loss of the red light in a downstream optical system is large. In this regard, since the present embodiment can reduce the loss of the red light LR, the optical output of the red light LR is sufficiently improved, so that the illuminator 700 having excellent color balance can be provided. The configuration of the present disclosure is therefore desirably applied to the red light LR rather than the green light LG and the blue light LB.

The illuminator 700 according to the present embodiment further includes the second red laser light source 14, which outputs the red light LR, and the second red laser light source 14 includes the second substrate 140 having the second surface 140a, the third red laser diode 143, which is provided at the second surface 140a and outputs the third red beam LR3 along the Y-axis direction, and the fourth red laser diode 144, which is provided at the second surface 140a and outputs the fourth red beam LR4 along the Y-axis direction. The third red laser diode 143 and the fourth red laser diode 144 are arranged along the X-axis direction. The first red laser light source 13 and the second red laser light source 14 are arranged along the X-axis direction. The first collimator lens array 2 further includes the second collimator lens 26 having the third region 26c, which the third red beam LR3 enters, and the fourth region 26d, which the fourth red beam LR4 enters. The third region 26c and the fourth region 26d are arranged along the X-axis direction in a state in which the second optical axis CX2 of the second collimator lens 26 is interposed therebetween. The constant deviation prism array 3 changes the traveling direction of the third red beam LR3 output from the third region 26c and the traveling direction of the fourth red beam LR4 output from the fourth region 26d in such a way that the chief ray of the third red beam LR3 and the chief ray of the fourth red beam LR4 travel along the second optical axis CX2. The constant deviation prism array 3 is disposed between the first collimator lens array 2 and the light collecting lens 50 at a position where the first distance X1 along the X-axis direction between the first red beam LR1 and the second red beam LR2, the second distance X2 along the X-axis direction between the second red beam LR2 and the third red beam LR3, and the third distance X3 along the X-axis direction between the third red beam LR3 and the fourth red beam LR4 are equal to each other when the first red beam LR1, the second red beam LR2, the third red beam LR3, and the fourth red beam LR4 are projected onto an imaginary plane perpendicular to the first optical axis CX1 and the second optical axis CX2.

According to the configuration described above, which can use the constant deviation prism array 3, in which the constant deviation prisms 34 having the same shape and the same dimensions are regularly arranged, the constant deviation prism array 3 is readily designed.

In the illuminator 700 according to the present embodiment, the intervals between the constant deviation constant deviation prisms of the constant deviation prism array 3 is equal to the first distance X1, the second distance X2, and the third distance X3.

According to the configuration described above, the red beams LR1, LR2, LR3, and LR4, which enter the constant deviation prism array 3 at a predetermined angle of incidence, are each less likely to enter the constant deviation prism 34 adjacent to the constant deviation prism 34 that the red light is supposed to enter. As a result, the amount of red light LR that is not made parallel to the optical axes CX1 and CX2 out of the red light output from the constant deviation prism array 3 can be reduced, so that the red light LR can be used at further increased efficiency.

To prove the advantages described above, the person who discloses the present disclosure conducted a simulation on the intensity distribution of the light at the second multi-lens surface 90b of the double-sided multi-lens array 90.

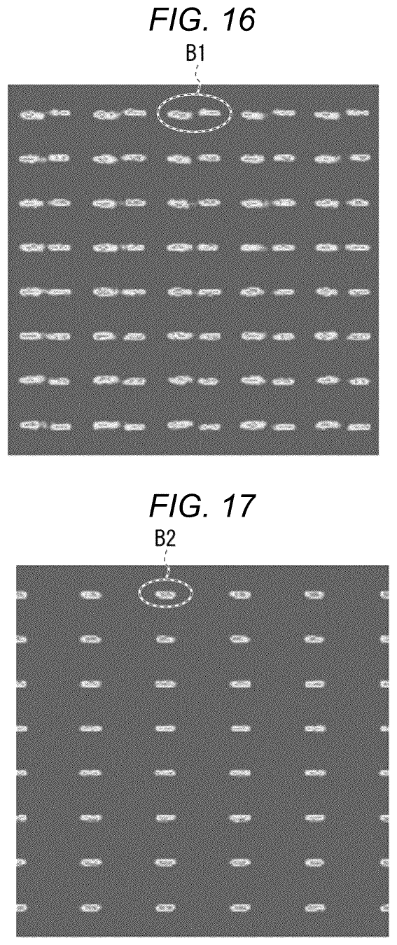

FIG. 16 shows a result of the simulation using the illuminator according to Comparative Example including no constant deviation prism array.

In the illuminator according to Comparative Example, an intensity distribution B1 of the light output from a single laser light source includes two secondary light source images, as shown in FIG. 16. The intensity distribution B1 is therefore elongated in the X-axis direction.

FIG. 17 shows a result of the simulation using the illuminator 700 according to the present embodiment including the constant deviation prism array 3.

In the illuminator 700 according to the present embodiment, an intensity distribution B2 of the light output from a single laser light source includes one secondary light source image, unlike in Comparative Example, as shown in FIG. 17. The amount of the spread of the intensity distribution B2 in the X-axis direction is therefore smaller than that in Comparative Example. As described above, the configuration of the present embodiment shows that the size of the secondary light source image can be reduced.

The projector 10 according to the present embodiment includes the illuminator 700 according to the present embodiment, the light modulators 400R, 400G, and 400B, which modulate light containing the combined light LW output from the illuminator 700 in accordance with image information, and the projection optical apparatus 600, which projects the light modulated by the light modulators 400R, 400G, and 400B.

The projector 10 according to the configuration described above can be a projector that excels in quality of a displayed image.

Note that the technical scope of the present disclosure is not limited to the embodiment described above, and a variety of changes can be made thereto without departing from the intent of the present disclosure.

For example, the illuminator according to the embodiment described above includes the rotary diffuser plate, and the diffuser plate is not necessarily be rotatable, and may be fixed.

In addition to the above, the specific descriptions of the shapes, the numbers, the arrangements, the materials, and other factors of the elements of the illuminator and the projector are not limited to those in the embodiment described above and can be changed as appropriate. The aforementioned embodiment has been described with reference to the case where the illuminator according to the present disclosure is incorporated in a projector using liquid crystal panels, but not necessarily. The illuminator according to the present disclosure may be incorporated in a projector using digital micromirror devices as the light modulators. The projector may not include multiple light modulators and may instead be a single-panel projector including only one light modulator.

The aforementioned embodiment has been described with reference to the case where the illuminator according to the present disclosure is incorporated in a projector, but not necessarily. The illuminator according to the present disclosure may be used in a lighting apparatus, a headlight of an automobile, and other apparatuses.

### Summary of Present Disclosure

The present disclosure will be summarized below as additional remarks.

### Additional Remark 1

An illuminator including:
a first light source configured to output light;
a collimator element configured to parallelize the light output from the first light source;
a light collector configured to collect light output from the collimator element and direct the collected light toward an illumination receiving region; and
a deflector disposed between the collimator element and the light collector,
wherein the first light source includes a first substrate having a first surface, a first light emitter disposed at the first surface and configured to output first light along a first direction, and a second light emitter disposed at the first surface and configured to output second light along the first direction,
the first and second light emitters are arranged along a second direction that intersects with the first direction,
the collimator element includes a first lens having a first region that the first light enters and a second region that differs from the first region and the second light enters,
the first and second regions are arranged along the second direction in a state in which a first optical axis of the first lens is interposed therebetween, and
the deflector is configured to change a traveling direction of the first light output from the first region and a traveling direction of the second light output from the second region in such a way that a chief ray of the first light and a chief ray of the second light each travel along the first optical axis.

According to the configuration described in the additional remark 1, the deflector can change the traveling direction of the first light and the traveling direction of the second light to suppress spatial spread of secondary light source images in the illumination receiving region. Loss of the first light and the second light in a downstream optical system can thus be suppressed, so that the first light and the second light can be used at increased efficiency.

### Additional Remark 2

The illuminator according to the additional remark 1, further including
second light source configured to output light,
wherein the second light source includes a second substrate having a second surface, a third light emitter disposed at the second surface and configured to output third light along the first direction, and a fourth light emitter disposed at the second surface and configured to output fourth light along the first direction,
the third and fourth light emitters are arranged along the second direction,
the first and second light sources are arranged along the second direction,
the collimator element further includes a second lens having a third region that the third light enters, and a fourth region that differs from the third region and the fourth light enters,
the third and fourth regions are arranged along the second direction in a state in which a second optical axis of the second lens is interposed therebetween,
the deflector is configured to change a traveling direction of the third light output from the third region and a traveling direction of the fourth light output from the fourth region in such a way that a chief ray of the third light and a chief ray of the fourth light each travel along the second optical axis, and
the deflector is disposed between the collimator element and the light collector at a position where a first distance along the second direction between the first light and the second light, a second distance along the second direction between the second light and the third light, and a third distance along the second direction between the third light and the fourth light are equal to each other when the first light, the second light, the third light, and the fourth light are projected onto an imaginary plane perpendicular to the first and second optical axes.

According to the configuration described in the additional remark 2, the deflector is readily designed.

### Additional Remark 3

The illuminator according to the additional remark 2, wherein
the deflector is a constant deviation prism array including a first constant deviation prism that the second light output from the second region enters, a second constant deviation prism that the first light output from the first region enters, a third constant deviation prism that the fourth light output from the fourth region enters, and a fourth constant deviation prism that the third light output from the third region enters,
the first, second, third, and fourth constant deviation prisms are arranged along the second direction, and
the first, second, third, and fourth constant deviation prisms each extend along a third direction that intersects with the first and second directions.

The configuration described in the additional remark 3 can provide a deflector that exhibits a desired function in accordance with the arrangement of the first, second, third, and fourth light emitters arranged along the second direction.

### Additional Remark 4

The illuminator according to the additional remark 3, wherein intervals between the constant deviation prisms of the constant deviation prism array are equal to the first, second, and third distances.

According to the configuration described in the additional remark 4, since the four kinds of light are each likely to enter the constant deviation prism that the light is supposed to enter, the amount of light that does not travel in a desired traveling direction can be reduced, so that the light can be used at further increased efficiency.

### Additional Remark 5

The illuminator according to the additional remark 3 or 4, wherein
the first constant deviation prism has a first light incident surface on which the second light is incident and a first light exiting surface via which the second light exits,
the second constant deviation prism has a second light incident surface on which the first light is incident and a second light exiting surface via which the first light exits,
one of the first light incident surface and the first light exiting surface is an inclining surface inclining with respect to an imaginary plane perpendicular to the first optical axis, and
one of the second light incident surface and the second light exiting surface is an inclining surface inclining with respect to the imaginary plane.

According to the configuration described in the additional remark 5, constant deviation prisms each having a desired function can be formed.

### Additional Remark 6

The illuminator according to the additional remark 5, wherein
either the first and second light incidence surfaces or the first and second light exiting surfaces are surfaces perpendicular to the first optical axis.

The configuration described in the additional remark 6 can provide advantages, for example, the constant deviation prism array can be readily manufactured and implemented, and optical loss at the boundary between the constant deviation prisms can be suppressed.

### Additional Remark 7

The illuminator according to any one of the additional remarks 1 to 6, wherein
the first and second light emitters are each a laser diode.

The configuration described in the additional remark 7 can realize a wide-color-gamut, high-efficiency illuminator.

### Additional Remark 8

The illuminator according to the additional remark 7, wherein
the first and second light emitters are each a red laser diode.

The configuration described in the additional remark 8 can increase the optical output of a red laser light source that is lower than those of a green laser light source and a blue laser light source.

### Additional Remark 9

The illuminator according to the additional remark 8, wherein
the red laser diode has a light emitting surface, and is so disposed that a longitudinal direction of the light emitting surface is oriented in the second direction, and a widthwise direction of the light emitting surface is oriented in a third direction that intersects with the first and second directions, and
a length of the first lens in the second direction is shorter than a length of the first lens in the third direction.

According to the configuration described in the additional remark 9, the size of the collimator element can be reduced.

### Additional Remark 10

A projector including:
the illuminator according any one of the additional remarks 1 to 9;
a light modulator to modulate light containing combined light output from the illuminator in accordance with image information; and
a projection optical apparatus configured to project the light modulated by the light modulator.

The projector described in the additional remark 10 can be a projector that excels in quality of a displayed image.

What is claimed is:

1. An illuminator including:
a first light source configured to output light;
a collimator element configured to parallelize the light output from the first light source;
a light collector configured to collect light output from the collimator element and direct the collected light toward an illumination receiving region; and
a deflector disposed between the collimator element and the light collector,
wherein the first light source includes a first substrate having a first surface, a first light emitter disposed at the first surface and configured to output first light along a first direction, and a second light emitter disposed at the first surface and configured to output second light along the first direction,
the first and second light emitters are arranged along a second direction that intersects with the first direction,
the collimator element includes a first lens having a first region that the first light enters and a second region that differs from the first region and the second light enters,
the first and second regions are arranged along the second direction in a state in which a first optical axis of the first lens is interposed therebetween, and
the deflector is configured to change a traveling direction of the first light output from the first region and a traveling direction of the second light output from the second region in such a way that a chief ray of the first light and a chief ray of the second light each travel along the first optical axis.

2. The illuminator according to claim 1, further comprising
second light source configured to output light,
wherein the second light source includes a second substrate having a second surface, a third light emitter disposed at the second surface and configured to output third light along the first direction, and a fourth light emitter disposed at the second surface and configured to output fourth light along the first direction,
the third and fourth light emitters are arranged along the second direction,
the first and second light sources are arranged along the second direction,
the collimator element further includes a second lens having a third region that the third light enters, and a fourth region that differs from the third region and the fourth light enters,
the third and fourth regions are arranged along the second direction in a state in which a second optical axis of the second lens is interposed therebetween,
the deflector is configured to change a traveling direction of the third light output from the third region and a traveling direction of the fourth light output from the fourth region in such a way that a chief ray of the third light and a chief ray of the fourth light each travel along the second optical axis, and
the deflector is disposed between the collimator element and the light collector at a position where a first distance along the second direction between the first light and the second light, a second distance along the second direction between the second light and the third light, and a third distance along the second direction between the third light and the fourth light are equal to each other when the first light, the second light, the third light, and the fourth light are projected onto an imaginary plane perpendicular to the first and second optical axes.

3. The illuminator according to claim 2, wherein
the deflector is a constant deviation prism array including a first constant deviation prism that the second light output from the second region enters, a second constant deviation prism that the first light output from the first region enters, a third constant deviation prism that the fourth light output from the fourth region enters, and a fourth constant deviation prism that the third light output from the third region enters,
the first, second, third, and fourth constant deviation prisms are arranged along the second direction, and
the first, second, third, and fourth constant deviation prisms each extend along a third direction that intersects with the first and second directions.

4. The illuminator according to claim 3, wherein
intervals between the constant deviation prisms of the constant deviation prism array are equal to the first, second, and third distances.

5. The illuminator according to claim 3, wherein
the first constant deviation prism has a first light incident surface on which the second light is incident and a first light exiting surface via which the second light exits,
the second constant deviation prism has a second light incident surface on which the first light is incident and a second light exiting surface via which the first light exits,
one of the first light incident surface and the first light exiting surface is an inclining surface inclining with respect to an imaginary plane perpendicular to the first optical axis, and
one of the second light incident surface and the second light exiting surface is an inclining surface inclining with respect to the imaginary plane.

6. The illuminator according to claim 5, wherein
either the first and second light incidence surfaces or the first and second light exiting surfaces are surfaces perpendicular to the first optical axis.

7. The illuminator according to claim 1, wherein
the first and second light emitters are each a laser diode.

8. The illuminator according to claim 7, wherein
the first and second light emitters are each a red laser diode.

9. The illuminator according to claim 8, wherein
the red laser diode has a light emitting surface, and is so disposed that a longitudinal direction of the light emitting surface is oriented in the second direction, and a widthwise direction of the light emitting surface is oriented in a third direction that intersects with the first and second directions, and
a length of the first lens in the second direction is shorter than a length of the first lens in the third direction.

10. A projector comprising:
the illuminator according to claim 1;
a light modulator configured to modulate light output from the illuminator in accordance with image information; and
a projection optical apparatus configured to project the light modulated by the light modulator.
